(19) United States
(12) Patent Application Publication
(10) Pub. No.: US 2012/0021740 A1
(43) Pub. Date: Jan. 26, 2012

(54) System and Method for Load Balancing and Handoff Management Based on Flight Plan and Channel Occupancy

(75) Inventors: Ravi Vaidyanathan, Belle Mead, NJ (US); Anthony Triolo, Manalapan, NJ (US)

(73) Assignee: TELCORDIA TECHNOLOGIES, INC., Piscataway, NJ (US)

(21) Appl. No.: 13/010,813

(22) Filed: Jan. 21, 2011

Related U.S. Application Data
(60) Provisional application No. 61/297,047, filed on Jan. 21, 2010.
(60) Provisional application No. 61/371,323, filed on Aug. 6, 2010.

(51) Int. Cl. H04W 36/32; H04W 4/04

(52) U.S. Cl. 455/431

(57) ABSTRACT

A predictive system and method for aircraft load balancing and handoff management leverages the aircraft flight plan as well as channel occupancy and loading information. Several novel techniques are applied to the load balancing and handoff management problem: Use of aircraft position and flight plan information to geographically and temporally predict the appropriate ground stations that the aircraft should connect to for handoff, and monitoring the load of ground stations and using the ground-requested, aircraft initiated handoff procedure to influence the aircraft to connect to lightly loaded ground stations.

### CROSS-REFERENCE TO RELATED APPLICATIONS

This application claims the benefit of U.S. Provisional Application No. 61/297,047, filed on Jan. 21, 2010 and U.S. Provisional Application No. 61/371,323, filed on Aug. 6, 2010, both of which are incorporated by reference herein in their entirety.

### FIELD OF THE INVENTION

The present invention relates to traffic control in aircraft networks and specifically to a predictive system and method for traffic load balancing and handoff management that leverages the aircraft flight plan as well as channel occupancy and loading information.

### BACKGROUND OF THE INVENTION

In current (VHF Digital Link) VDL Mode 2 networks, aircraft that traverse the signal coverage boundaries of VHF Ground Stations (VGSs) perform handoffs to the VGS that has the strongest signal, so as to maintain acceptable signal quality. In lightly loaded networks, this method of maintaining link connectivity proves quite effective. However, as the FAA prepares to transform the National Airspace System (NAS) through the Data Communications and NextGen programs to more heavily utilize VDL-2 links for several purposes, VDL-2 traffic is expected to increase significantly.

Currently, aircraft select VHF Ground stations based primarily on signal quality (as long as they belong to the Communications Service Provider with whom they contract with). When aircraft handoff between VGS stations, they may also consider additional factors to discriminate between candidate stations, such as:

1. Ground stations are connected to the same Air/Ground (A/G) router and

2. If the candidate VGS covers the destination airport.

In particular, the current state of the art will result in all aircraft bound to the same destination airport associating to the same ground station, irrespective of the capacity available at the ground station. This could in turn result in highly loaded “hot spots”—VGSs that are heavily loaded along an aircraft's flight path, while adjacent VGSs with acceptable signal quality and low loading, will be not be selected by the aircraft.

Mechanisms exist in VDL standards to perform handoff—ground requested, aircraft initiated handoff, for example, ground requested, aircraft initiated handoff. This mechanism allows a ground station to request that an aircraft perform a handoff.

It is acknowledged that the autotune frequency parameter may enable a ground station to manage multiple frequencies in a congested area. The ground station may use this mechanism to request that an aircraft re-tune to a different frequency and initiate link establishment on the new frequency, in cases that correspond to the situation described above (where some frequencies or ground stations are congested while others are lightly loaded).

Cellular load balancing techniques exist and have been investigated. The Telcordia AutoRF product is one example.

Under certain conditions, it may be advantageous for aircraft to connect to VGS that may not have the strongest signal quality, but are more lightly loaded than VGSs with the best signal quality.

Further, similar scenarios can be outlined for multi-frequency operation. A single VGS may operate with multiple frequencies wherein aircraft associate with one of those frequencies causing it to be highly loaded, while other frequencies are lightly loaded.

Another problem is the frequency recovery mechanism that is the current procedure for handoff management. Aircraft remain connected to their current VGS until the signal quality deteriorates below a defined threshold. Then they tune to the common signaling channel (CSC) to locate other candidate ground stations, and tune into the appropriate frequency and begin link establishment with the new ground station. Significant latency is involved in the frequency recovery procedure outlined above.

In a heavily loaded VDL-2 network, it would be possible to overload a VGS by offering more packet traffic to it than it can accommodate thus resulting in deterioration of quality of service metrics associated with the VGS (e.g., latency). Such overloads are possible even if the aggregate capacity of the VDL-2 system is sufficient to carry the aggregate offered load. Overloads like this can occur when air traffic is spatially non-uniformly distributed, creating “hot-spots” on certain VGSs. Since aircraft are constrained to flight paths, such spatial non-uniformity is inevitable. The present invention presents a technique that can alleviate “hot-spot” overloading using a predictive load balancing technique that works within the constraints of the current VDL-2 standards.

A VDL Mode 2 network can be considered a cellular network in that each VHF Ground Station (VGS) provides a “cell” of limited geographic coverage, while a collection of cells can provide signal coverage over a wide area (see FIG. 1 for an example of VDL-2 coverage as seen from an aircraft flying at 16,000 feet with VGSs placed at all major airports and some regional airports in order to achieve Continental United States (CONUS) coverage).

To allow for continuous radio service, there must be some overlap between VGS coverage areas, thus providing some signal redundancy on the cell boundaries where signal strength is lowest. Since aircraft need to maintain connectivity all the way to the terminal, VGSs are necessitated at all airports where VDL-2 service is required. It follows that in densely populated areas, where there are several airports in close proximity, that many VGSs are visible while airborne in that area. Signal connectivity is maintained as an aircraft traverses these cell boundaries through handoff procedures that allow the aircraft to direct its communications at the best serving VGS at any time.

Once an aircraft has established a link to a VHF Ground Station (VGS), its Link Management Entity (LME) begins monitoring the signal quality to that ground station and to other surrounding ground stations. When the signal quality to the currently connected VGS becomes poor, and the signal to another VGS becomes significantly better, the aircraft's LME tries to establish a link to a new ground station. The procedure is described in “VHF Digital Link (VDL) Mode 2 Implementation Provisions”, ARINC Specification 631-5, December 2008.

In addition to signal quality triggers for handoffs, too many packet retransmissions, or timeout of certain network timers can cause initiation of handoffs, as well. This process is called “Frequency Recovery”. Relying on these mechanisms to reduce load on heavily loaded VGSs, however, can lead to unacceptable levels of latency and overall degradation of performance on the affected VGSs. Further, the Frequency Recovery process is typically initiated once the signal quality deteriorates, potentially leaving the aircraft without a functional or degraded data-link for an extended period of time.

Hot-spot overloading is not unique to VDL-2 networks. Cellular network operators have been dealing with hot-spots for many years. Several solutions have been proposed for hot spot relief, including antenna beam forming techniques to move load from one cell to another described in P. Viswanath, D. N. C. Tse and R. Laroia, “Opportunistic beamforming using dumb antennas,” IEEE Trans. on Inform. Theory, Vol. 48, No. 6 (June 2002) pp. 1277-1294, and time-of-day and day-of-week cell size modifications to accommodate varying load conditions described in Telcordia® Auto RF cellular network optimization software product, found on the internet at http://www.telcordia.com/innovation/network_operations/network-optimization.html.

There are several differences between terrestrial cellular networks and air-to-ground VDL-2 networks that make direct application of the terrestrial cellular techniques inappropriate. First, the operational frequency of the VDL-2 links is much lower than that of the cellular networks (˜125 MHz for VDL-2, compared to 900 MHz or 1900 MHz for terrestrial cellular). This lower operational frequency makes use of antenna arrays with large numbers of elements for beam forming and adaptive downtilt techniques impractical at both the ground station and the aircraft due to size limitations associated with element spacing and a relatively low frequency (large wavelength). Second, signal propagation in terrestrial cellular networks experiences attenuation at a rate much greater than that of the mainly free space propagation experienced in air-to-ground links and allows tighter control of cell edges and more flexibility in using power level to control cell sizes and hence, control load.

There is an advantage, however, that VDL-2 networks have over terrestrial cellular networks; that is, the predictability of the flight paths of the aircraft and the knowledge of their current locations. It is this predictability that is exploited to provide a predictive handoff method to alleviate hot-spots and provide improved quality of service throughout the network.

### SUMMARY OF THE INVENTION

Prior art mechanisms do not address the following:
Latency associated with handoff, in particular incurring the penalty of the link establishment delay multiple times, first when associating with a ground station, and then again subsequent to the ground station supplying an autotune frequency parameter because it is congested, and re-tuning to a new ground station.
Absence of a predictive mechanism for autotune.
Frequency recovery procedural latency is not addressed.

### VDL Mode 2 Handoff Mechanisms

When an aircraft VDL-2 radio first powers-on, initial radio contact is established through the Common Signaling Channel (CSC), which is on a single common frequency. The CSC also serves as the fallback communication channel for aircraft to locate new ground stations or in cases when handoff fails. Ground Station Information Frames (GSIF) are broadcast on the CSC in order to identify them to aircraft.

The ARINC 631-5 Specification states that it is the responsibility of the LME on the aircraft to manage all handoffs within the same ground system. There are two types of handoffs defined in this specification. First, there is Aircraft-Initiated handoff, in which the aircraft sends the XID_CMD_HO message to the ground station requesting a handoff (the ground responds with XID_RSP_HO). Second, there is Ground-Requested Aircraft-Initiated handoff. In this case, the VGS sends an XID_CMD_HO message to the aircraft, and the aircraft starts an Aircraft-Initiated handoff.

The aircraft monitors signal quality (SQP) for the currently connected VGS and on frequencies listed in the GSIF “Frequency Support List” parameter. When the signal quality from the current VGS is poor and the signal quality from another VGS is better, the aircraft can initiate a handoff by sending the XID_CMD_HO message. The ground station responds with the XID_RSP_HO message containing the frequency with which the aircraft is expected to tune to using the Autotune function. The Autotune function allows the VGS to command the aircraft to change frequencies without manual intervention of a radio operator described in “Signal-in-Space Minimum Aviation System Performance Standards (MASPS) for Advanced VHF Digital Data Communications Including Compatibility With Digital Voice Techniques”, RTCA DO-224A, http://www.rtca.org, 13 Sep. 2000.

### Cell Boundary Predictions

It is possible to predict cell boundaries at various altitudes using a propagation modeling tool that is capable of simulating air-to-ground propagation conditions. For instance, Telcordia's WINPLAN network planning tool contains the Gierhart-Johnson (IF-77) air-to-ground propagation model and can be used to predict performance of VDL-2 cell boundaries. This type of simulated result can be used to generate handoff candidate lists for populating the GSIF Frequency Support List parameter in the VGSs.

WINPLAN has also been used to compute the number of visible VGSs above a certain received power threshold and has shown that in most areas of the US, many ground stations are visible from any particular point. This implies that there are several handoff candidates at most locations in these areas that have acceptable signal levels across which load can be shifted.

In terrestrial cellular systems, when a Base Transceiver Station (BTS) (equivalent of a VGS) senses that a Mobile Station (MS) (equivalent to the aircraft) is experiencing poor signal quality, as evidenced in the Bit Error Rate (BER), it commands the MS to send a report of measured signal strength to the surrounding BTSs (see, M. Mouly and M. Pautet, The GSM System for Mobile Communications. Palaiseau, France: Cell & Sys, 1992, pp. 331). Since there is no mechanism such as this available in VDL-2 links, the ground system may have to rely on predictions from a propagation planning tool to decide which VGSs should be visible to the aircraft when making handoff suggestions.

The present invention applies several novel techniques to the load balancing and handoff management problem: Use of aircraft position and flight plan information to geographically and temporally predict the appropriate ground stations that the aircraft should connect to for handoff, and monitoring the load of ground stations and using the ground-requested, aircraft initiated handoff procedure to influence the aircraft to connect to lightly loaded ground stations.

The invention provides an advantage over prior solutions in the following ways:

Compared to the standard autotune technique: the invention uses the autotune mechanisms along with load information for all ground stations in the network to handoff to the ground station that has not just the best signal level, but to the ground station that has a reasonable signal level, one that is not highly loaded, and one that provides coverage for a large portion of the aircraft's upcoming flight path.

Compared to previous cellular methods: the invention does not modify cell boundaries or ground station power levels to achieve load balancing. The inventive method does not require modification of the packet scheduling algorithms. The present method uses flight path information to provide optimal predictive handoff choices.

The present invention will be better understood when the following description is read in conjunction with the accompanying drawings.

### BRIEF DESCRIPTION OF THE DRAWINGS

FIG. 1 is a graphical representation of an example of VDL-2 coverage.

FIG. 2 is a graphical representation of a load balancing case.

FIG. 3 is a block diagram of a predictive handoff system

FIG. 4 is a block diagram of a pro-active load balancing system.

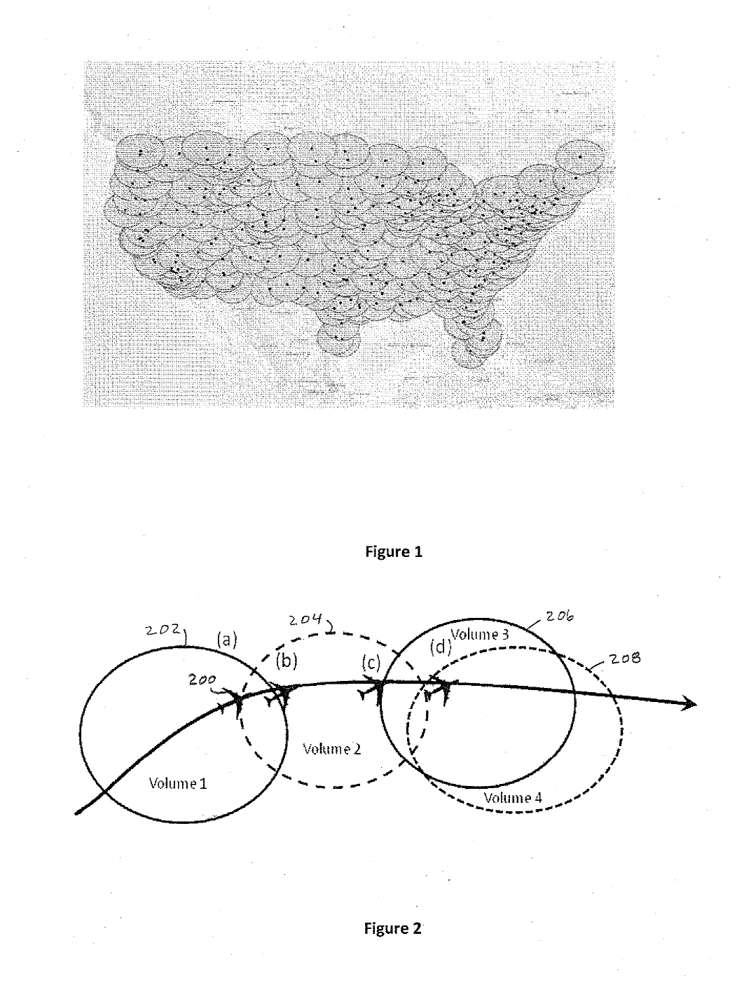

### DETAILED DESCRIPTION

As mentioned above, in many parts of the airspace over CONUS, an aircraft has acceptable signal strength to several VGSs. Based on the current methods outlined in the VDL-2 specifications, the aircraft will typically choose the VGS with the strongest signal. In a network with non-uniform loading of VGSs, this is not always the choice that will lead to the best overall link performance in terms of packet latency.

Even when the p-persistent Carrier Sense Multiple Access (CSMA) protocol used by the VDL-2 standard is working perfectly (without hidden terminals), as the number of nodes trying to access the ground station increases, the throughput to that VGS decreases as described in A. S. Tanenbaum, Computer Networks, 3^{rd} Edition. Upper Saddle River, N.J.: Prentice Hall PTR, 1996, pp. 251-254. Hidden terminals are present in these networks since adjacent VGSs can rarely hear each other due to the large physical separation, while aircraft can hear many of these VGSs. Presence of hidden terminals decreases throughput even further.

Overload conditions can be alleviated by shifting aircraft onto other frequencies, reducing the number of packet transmissions on the overloaded frequency. In the currently used system, the only way for an aircraft to be shifted to another frequency is to experience reduction in signal quality from its currently connected VGS (and corresponding increase in signal quality from another VGS), reaching the maximum number of retries while sending a packet, or waiting for the channel-busy timer to timeout. The system of the present invention seeks to preemptively shift aircraft to other visible frequencies before any of these conditions occur.

The network load balancing method of the present invention does not wait for handoff requests to originate from an aircraft, indicating low signal strength. Instead, the method takes advantage of procedures defined in the ARINC Specification for Ground-Requested Aircraft Initiated Handoff whereby a ground station can request an aircraft to initiate a handoff to one of the ground stations specified in a Replacement Ground Station List. Careful selection of the ground stations in this Replacement Ground Station List can then mitigate problems with existing techniques:

1. Selection of replacement ground stations based not only on the signal strength but also based on the ground station or cell loading. Thus, lightly loaded ground stations would be preferred over heavily loaded ground stations, if they have substantially similar coverage areas.

2. Selection of ground stations based on overlap with the aircraft flight path as well as destination airport coverage, if applicable.

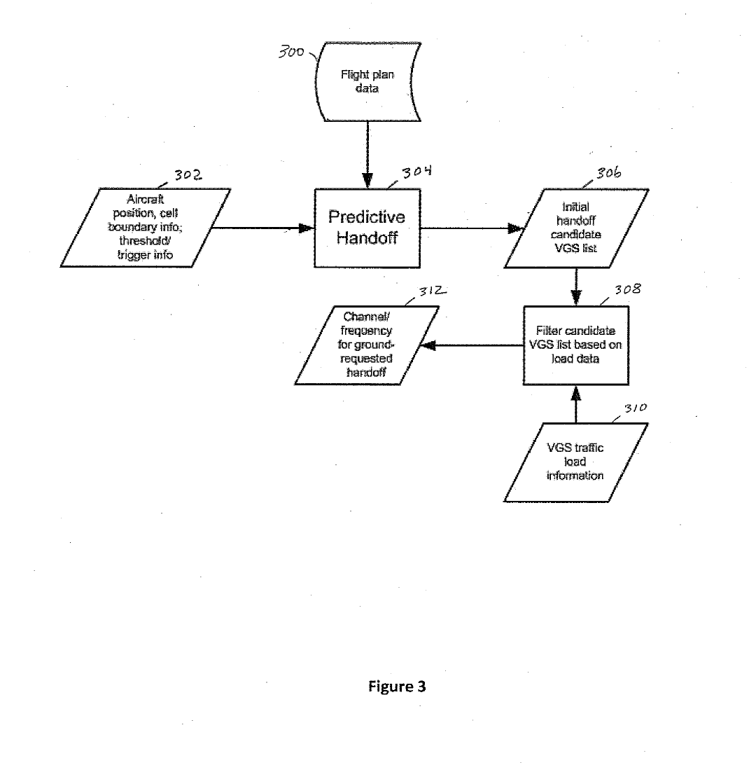

An example scenario depicting this process is shown as an example scenario walkthrough in FIG. 2 A block diagram showing the functional components necessary that would comprise a predictive handoff system are shown in FIG. 3.

Referring to FIG. 2:

(a) Aircraft 200 approaches boundary of Volume 1 202; VGS1 retrieves aircraft position from external data sources, predicts upcoming handoff to Volume 2 204 from flight data object.

(b) VGS1 sends ground-requested handoff message to aircraft to establish link to VGS2 on frequency F2. Aircraft initiates and completes link establishment to VGS2 in Volume 2 204 without performing a frequency recovery procedure.

(c) Aircraft approaches boundary of Volume 2 204; VGS2 retrieves aircraft position from broadcast information, predicts upcoming handoff to Volume 3 206 or Volume 4 208; Volume 4 is selected owing to high current load in Volume 3.

(d) VGS2 sends ground-requested handoff message to aircraft to establish link to VGS4 on frequency F4. The aircraft initiates and completes link establishment to VGS4 in Volume 4 without performing a frequency recovery procedure.

To implement this type of system, the ground system needs to be aware of the current location of the aircraft requesting handoff, and its flight path. Aircraft location information can be obtained from data sources such as, but not limited to, Automatic Dependent Surveillance-Broadcast (ADS-B) http://www.faa.gov/air_traffic/technology/ads-b/ or from the FAA's Aircraft Situation Display to Industry (ASDI) http://www.fly.faa.gov/ASDI/asdi.html. Flight plan information can be obtained through systems such as En-Route Automation Modernization (ERAM) http://www.faa.gov/air_traffic/technology/eram. Also load monitoring information (near real-time) per VGS/Volume and ground requested, aircraft initiated auto-tune functionality is necessary.

Referring to FIG. 3, the aircraft has a filed flight plan 300. As the aircraft approaches the boundary of a volume the VGS retrieves aircraft position from external data sources 302. Predictive Hand-off 304 predicts upcoming handoff to Volume 2 from the flight plan data and the flight data object. The local VGS sends ground-requested handoff message to the aircraft to establish link to the next VGS on a new frequency 306. The current VGS sends the ground-requested handoff message to the aircraft to establish a link with the next VGS on the proper frequency. As the aircraft approaches the boundary of Volume 2 VGS2 retrieves aircraft position and predicts an upcoming handoff to either Volume 3 or Volume 4 308. VGS traffic load information is obtained 310. Based on the high current load in Volume 3, VGS2 sends ground-requested handoff message to aircraft to establish link to VGS4 on Frequency F4 312. The aircraft initiates and completes link establishment to VGS4 in Volume 4 at the frequency F4 without performing a frequency recovery procedure.

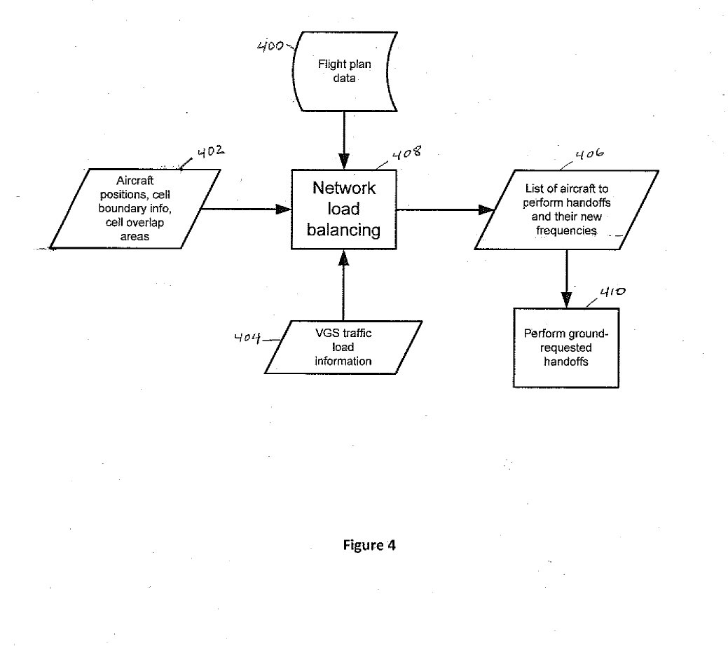

A second method for performing network load balancing is a pro-active method that triggers ground-requested aircraft-initiated handoffs based only on network load (as opposed to when an aircraft approaches a cell boundary) as shown in FIG. 4. In addition to filed flight plan data 400 and retrieved aircraft position data from external sources 402, when a VGS (or multiple VGSs) approaches a critical load condition, a search is conducted through the list of currently active aircraft attached to that heavily loaded VGS 404 to look for candidates that can be handed-off 406. Using the predicted coverage maps, Network Load Balancing 408 finds areas where multiple VGSs are expected to be visible and hand-off aircraft that fall in those regions to other, more lightly loaded VGSs that are visible 410.

### Impact on Network Performance

While an aircraft has an established link, it monitors signal-strength to determine if a handoff is necessary. The other conditions that trigger a handoff in cases where the signal level is still acceptable are the timeout of the channel-busy timer TM2 and exceeding the retransmission counter N2. The channel busy timer TM2 has a minimum value of 6 seconds, a maximum value of 120 seconds and a default value of 60 seconds. The maximum number of transmissions parameter N2 has a minimum value of 1 and a maximum value of 15, with a default of 6. Waiting for timer TM2 or counter N2 before choosing an alternate frequency from the Frequency Support List can result in latencies on the order of minutes during times of congestion.

In cases of high network load, as an aircraft attempts its next packet transmission, it may experience a timeout of timer TM2 or counter N2 due to too many competing packet requests on the serving ground station (the strongest one at this location in space). Current operating procedure would cause the aircraft to go into the frequency recovery mode where it tunes to candidate frequencies listed in the GSIF Frequency Support List. The aircraft will dwell on that frequency while attempting to establish a link for as long as specified by timer TG1, which has a typical value of 600 seconds, or 10 minutes. If other channels in this list are also heavily loaded, it could take several attempts to establish a new link on a lightly loaded VGS, which could result in 10s of minutes of delay and lost connection. Using the proposed load balancing mechanism, the VGS with the lightest load will be indicated for a ground-requested handoff, thus avoiding delays associated with frequency recovery for this particular aircraft.

In addition to the benefits associated with handoff of a particular aircraft, in a network that implements the proposed load balancing technique, overall load will be more equally distributed resulting in fewer hotspots and less reliance on frequency recovery processes. This can result in overall lower network wide latency.

As VDL-2 networks become more widely deployed and used for transporting FAA Air Traffic Control (ATC) messages in addition to current applications involving. Airline Operational Communications (AOC) traffic there will be increasing emphasis on the performance and reliability of VDL mode 2 networks. The present invention provides predictive load balancing and handoff management for VDL networks that have the potential to substantially alleviate significant deployment issues including the formation of traffic “hot-spots” within, the VDL network as well as reduce the latency and performance deterioration associated with handoff.

Various aspects of the present disclosure may be embodied as a program, software, or computer instructions embodied in a computer or machine usable or readable device, which causes the computer or machine to perform the steps of the method when executed on the computer, processor, and/or machine.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or the like.

While there has been described and illustrated system and method for aircraft load balancing and handoff management that leverages the aircraft flight plan as well as channel occupancy and loading information, it will be apparent to those skilled in the art that variations and modifications are possible without deviating from the broad teachings of the present invention which shall be limited solely by the scope of the claims appended hereto.

What is claimed is:

1. A method for aircraft load balancing and handoff management comprising:
retrieving flight plan data for an aircraft;
retrieving aircraft position data from external data sources;
predicting radio coverage regions of VHF Ground Stations (VGS);
predicting a list of candidate VGSs for handoff based on the retrieved flight plan data, retrieved aircraft position data and the radio coverage regions of the VGSs;
obtaining channel occupancy and traffic load data for VGSs on the list of handoff candidates;
predicting handoff of the aircraft to one of a list of handoff candidate VGSs based on the retrieved flight plan data, retrieved aircraft position data, channel occupancy and traffic load data and radio coverage regions of VGS; and
initiating the handoff of the aircraft to the predicted VGS.

2. A method as set forth in claim 1 wherein the handoff is initiated by the aircraft.

3. A method as set forth in claim 1 wherein the handoff is initiated by the VGS.

4. A computer readable device having computer readable program code for operating on a computer for aircraft load balancing and handoff management comprising:
retrieving flight plan data for an aircraft;
retrieving aircraft position data from external data sources;
predicting radio coverage regions of VHF Ground Stations (VGS);
predicting a list of candidate VGSs for handoff based on the retrieved flight plan data, retrieved aircraft position data and the radio coverage regions of the VGSs;
obtaining channel occupancy and traffic load data for VGSs on the list of handoff candidates;
predicting handoff of the aircraft to one of a list of handoff candidate VGSs based on the retrieved flight plan data, retrieved aircraft position data, channel occupancy and traffic load data and radio coverage regions of VGS; and
initiating the handoff of the aircraft to the predicted VGS.

5. A computer readable program as set forth in claim 4, wherein the handoff is initiated by the aircraft.

6. A computer readable program as set forth in claim 5, wherein the handoff is initiated by the VGS.
